(19) United States
(12) Patent Application Publication
(10) Pub. No.: US 2010/0325020 A1
(43) Pub. Date: Dec. 23, 2010

(54) Systems and/or methods for globally tracking items and generating active notifications regarding the same

(75) Inventors: Peter J. Junger, Redmond, WA (US); Dustin Ares, Woodinville, WA (US)

Correspondence Address: NIXON & VANDERHYE, P.C., 901 NORTH GLEBE ROAD, 11TH FLOOR, ARLINGTON, VA, 22203, US

(73) Assignee: NINTENDO OF AMERICA, INC., Redmond, WA (US)

(21) Appl. No.: 12/801,677

(22) Filed: Jun. 21, 2010

Related U.S. Application Data
(63) Continuation-in-part of application No. 12/314,150, filed on Dec. 4, 2008.

(51) Int. Cl. G06Q 10/00

(52) U.S. Cl. 705/28

(57) ABSTRACT

Certain exemplary embodiments relate to techniques for fraud reduction and/or product recovery. For example, in certain exemplary embodiments, a central repository for item-level data related to stolen, missing, counterfeit, or other items may be provided. The item-level data may be stored as a function of EPC/RFID and/or serial number information in certain exemplary embodiments of this invention. According to certain exemplary embodiments, notification and/or subscription systems may be deployed to search for missing, stolen, or other items throughout the various “touchpoints” in the sales universe by consulting the centralized electronic registration (ER) database. This searching may be performed among and between, and/or on behalf of, interested parties including, for example, retailers, manufacturers, pawnshops, online auction houses, etc. These and/or other parties may be notified, as appropriate, with the notifications being based on subscriptions may by the entities and/or predefined rules.

### CROSS-REFERENCE TO RELATED APPLICATION

This application is a continuation-in-part of U.S. application Ser. No. 12/314,150, the entire contents of which are hereby incorporated herein by reference.

### TECHNICAL FIELD

The technology disclosed herein relates to fraud prevention and recovery using an electronic system for registering product transactions. More particularly, the disclosed technology herein relates to theft/fraud prevention, detection, and recovery using an electronic registration system accessible by theft/fraud prevention and recovery agencies that also automatically monitors products' statuses and automatically alerts interested parties of suspect activities.

### BACKGROUND AND SUMMARY

Federal law enforcement authorities estimate as much as $30 billion in merchandise is stolen annually by theft rings. According to the National Retail Federation, in 2006 retailers lost $9.6 billion due to fraudulent returns alone. The most popular store-return fraud, according to the National Retail Federation, is the return of stolen merchandise. Merchandise returned that was originally purchased with fraudulent or counterfeit tender ranks second, followed by returns using counterfeit receipts. The multibillion-dollar problem impacts not only retailers and corporations, but also everyday consumers.

Credit cards, checks, gift cards, etc., when stolen or counterfeited using identity theft techniques, are used soon after to buy merchandise or new gift cards before a person can report the theft. These purchases are then liquidated and converted to cash or store credit. Store credit can then be used to make “legitimate” purchases which, in effect, “launders” the criminally-acquired tender and conceals the original fraudulent activity from detection.

Some exemplary methods used to liquidate merchandise are on-line auction houses such as eBay, CraigsList and pawn shops. Merchandise is also sold privately, sold to unsuspecting or corrupt retailers/mom-and-pop shops, or is fraudulently returned back to a store (often the same store from which the merchandise was stolen) for cash refunds or in-store credit.

Currently, products obtained via fraudulent sales transactions and through theft cannot be traced to the original store transaction or to the fraudulent tender used in the sales transaction (unless checked using static techniques provided, for example, by the assignee of the instant invention in its current electronic registration (ER) systems). Thus, even if the product is recovered, it cannot be positively linked to a particular store and/or to a specific sales transaction. As a result, law enforcement agencies may be deterred from investigating or prosecuting cases when a specific victim(s) cannot be identified.

Retail/store inventory theft is a sizable and a growing problem in the U.S. Dishonest employees, customers, and criminal gangs steal many of these items for the purpose of returning them back to the store for cash or in-store credit.

Retailers/stores are faced with a challenging and expensive task and face tradeoffs with securing/protecting their assets while trying to openly display merchandise, which has proven to increase sales. Retailers resort to locking valuable items behind secured glass, attaching security source tags to the packaging, installing video surveillance equipment and employing other security devices, many of which are expensive and detract from sales and do not fully protect against employee theft. Although these security devices/steps do help deter theft, often they are circumvented by criminals who remove items from the packaging and/or grab several items and run through the store exit door, use duplicate/counterfeit receipts, or use found receipts to return them. Criminals have also been known to use legitimate receipts to steal items of a similar model or UPC to the one on the receipt and fool store greeters and/or security guards when the greeter/guard verifies purchases at the store exit, etc.

Items involving found receipts/counterfeit receipts may never even physically leave the store. Criminals simply remove a similar item from a store's shelf and take it directly to the store's customer service/returns desk for a cash refund or an in-store-credit.

Another challenge faced by retailers is proving to law enforcement that they have ownership of recovered stolen items. If items are stolen off of a truck before they ever make it to a retailer, the item may have no tag or other association with the retailer affixed thereto. If the item is subsequently recovered by the police, it is difficult, if not impossible, for a particular retailer to prove that the item belongs to them.

The exemplary illustrative non-limiting implementations provide an electronic registration system that enables individual product identification information to be gathered at the point of shipment and/or transaction. This information may be added to one or more transaction databases as a record associated with that transaction. For example, if a credit card, check card, gift card, etc., is stolen and a purchase transaction is determined, after-the-fact, to have been fraudulent based on the use of the stolen card, the record associated with the fraudulent sales transaction may be flagged in the central database. The central database may also be updated, for example, with the nature of the fraud committed and the contact information of the party reporting the fraud. According to this exemplary illustrative non-limiting implementation, credit-card companies, retailers, insurance companies, law enforcement, retail asset protection investigators, etc., can make use of this reporting aspect.

Methods and techniques for point-of-sale (POS) registration of goods are taught in U.S. Pat. No. 5,978,774, the contents of which are incorporated herein by reference. In an exemplary environment, individual product identification information (such as a serial number or EPC/RFID, etc.) is stored in a local transaction database, along with additional information, such as the date of the transaction, transaction number, etc. A transaction receipt, such as a customer sales receipt, is created and may include the individual product identification information and the date of the transaction. Additionally, the individual product identification information and the transaction date may be communicated to a separate location for inclusion in a general transaction database. The local transaction database may include, for example, sales made by a particular store or sales made by several affiliated stores and is not necessarily co-located with the point of sale.

Where a serial number is used to identify the individual product, one or more check digits may also be used in conjunction with the serial number. In this way, the validity of the serial number may be verified and, if it is invalid, a system operator may be prompted to re-enter the serial number. The serial number may be scanned, entered with a keypad, or input with any other suitable technique. Other suitable methods for validating the serial number are also contemplated. See, e.g., U.S. Pat. No. 6,947,941, the entire contents of which are hereby incorporated herein by reference.

Prior to obtaining individual product identification information, the electronic registration system may identify the type of product by evaluating, for example, the product SKU number derived from a universal product code (UPC) or electronic product code (EPC), or the like. In one exemplary implementation, the individual product identification information is obtained only if the product is of a type for which electronic registration is desired.

The point of transaction information, including information such as the individual product identification information and the transaction date, transaction number, etc., may be communicated for use in a general database in a number of different ways. For instance, an electronic link to the location of the general database may be established or information may be recorded and physically transferred to that location. The communications may occur periodically, on an item-by-item basis, in batch, or otherwise.

In one exemplary illustrative non-limiting implementation, all of the information stored with any given ID is product, not customer related. That is, for any given purchase, while a unique item ID, date of purchase, price of purchase, place of purchase, etc., may be stored, all the information is product, not person, oriented. This ensures that a certain level of security and customer privacy is associated with the database of this exemplary implementation. If the database is hacked or otherwise wrongfully accessed, no customer information can be had. At the same time, one can identify a product within the database through one or more of the identifiers.

If, for example, a TV is stolen, and the customer knows when, where, the brand name, etc., of the purchase, and how much they paid for it, the unique ID can be retrieved and that item can be flagged as stolen, without the customer having to give any personal information up for storage in the database. Of course, personal information can be stored if desired, and if a product is stolen, a customer may request that some personal contact information (e.g., a non-descriptive email address such as xyz123@hotmail.com) be associated with that product in the event that it is recovered.

According to another exemplary illustrative non-limiting implementation, in order to track what merchandise should be on the shelves at a given time, items may be registered with a database upon shipment to a retailer, receipt by a retailer, or at some other suitable time. If those items are again subsequently registered when sold, then it can easily be determined if an item that is being returned is one that was sold legitimately, sold in connection with a fraudulent transaction, or not sold at all.

In this exemplary implementation, if the serial number of the product is scanned when returned, the retailer can quickly see the record associated with that unique registration number and determine whether a refund/credit should be given or whether the authorities should be contacted. Such a determination can even be done automatically. Since the database may be referenced at the point of the transaction, as opposed to a later time, the store security could be contacted as soon as the fraud was discovered. Of course, these suspect transactions may be accessed in batch and investigated later.

In a further exemplary illustrative non-limiting implementation, if an open empty package is discovered in a store, the package's unique serial number matching the product serial number is scanned and the item is identified and/or flagged as lost/stolen. If later the item is found (e.g., in the store), re-packaged, and legitimately sold, then the item registration at point of sale overrides the lost/stolen status. Alternatively, if someone tries to return the item, the database will show that this item was never purchased and/or stolen. This can be useful in preventing people from opening a package in a store and attempting to return without the packaging while still inside the store, which is a common practice used to circumvent the security source tag (oftentimes provided by Sensormatic, Checkpoint, or another company) usually affixed to the packaging and not the product itself.

According to yet another exemplary illustrative non-limiting implementation, consumers can also utilize the database to register personal items. If those items are lost or stolen, then registrations, based on, for example, serial numbers, can be accessed and a flag of “lost” or “stolen” can be added. If the goods are recovered or turn up, say, in a pawn shop, law enforcement officials or the pawn shop owner can check the database to determine the status of the goods and to whom they belong, and/or contact the rightful owner, e.g., via a previously provided anonymous email address (e.g., xyz123@hotmail.com).

Numerous parties will find such a fraud prevention/recovery system useful. A non-exhaustive exemplary list includes: retailers, law enforcement, courts, pawn shops, online auction houses, individuals, etc. In one exemplary illustrative non-limiting implementation, anyone with a pre-approved pass-code can access the database. Access can be had using, for example, the Internet, a computerized register, a telephone, wireless devices operable to connect to the database, etc.

Another exemplary illustrative non-limiting application of the crime prevention database (CPD) to verify that a particular product belongs to a particular retailer. Since retailers generally receive products in blocks with serial numbers in numeric order, the CPD can be used to verify which surrounding serial numbers were purchased/sold by a retailer. If it can be proven that all serial numbers surrounding the serial number of a recovered item correspond to a certain retailer, it is likely that the stolen item belongs to that particular retailer and further investigation can ensue.

In certain exemplary embodiments a fraud reduction and product recovery system is provided. A database includes a plurality of product entries, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. Product checking programmed logic circuitry is configured to determine whether the product to be checked was legitimately acquired. The second interface is further configured to provide an indication to the second authorized user whether the product was legitimately acquired.

In certain exemplary embodiments, in a fraud reduction and product recovery system, a method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

In certain exemplary embodiments, a computer-readable storage medium tangibly storing instructions for causing a computer to implement a fraud reduction and product recovery method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

One aspect of certain exemplary embodiments relates to a central repository for item-level data related to stolen, missing, counterfeit, or other items. The item-level data may be stored as a function of EPC/RFID and/or serial number information in certain exemplary embodiments of this invention.

Another aspect of certain exemplary embodiments relates to active notification and/or subscription systems that may be used to search for missing, stolen, or other items throughout the various “touchpoints” in the sales universe. This searching may be performed among and between, and/or on behalf of, interested parties including, for example, retailers, manufacturers, pawnshops, online auction houses, etc., in certain exemplary embodiments of this invention.

Still another aspect of certain exemplary embodiments relates to these and/or other parties being notified when an unexpected activity is encountered and/or when an item is flagged as lost or stolen, with the dissemination of the notifications being based on subscriptions made by the entities and/or on predefined rules, specifying who is to receive what notifications and when the notifications are to be provided.

In certain exemplary embodiments of this invention, a computer-implemented method for identifying the movement of suspect items is provided. Item-level data for a plurality of items is received at a centralized electronic registration (ER) database connected to a network. The item-level data in the centralized ER database is updated as items in said plurality of items progress through respective product lifecycles. Stakeholders are notified upon each occurrence of an unexpected event being detected by the ER database and upon each time a particular item in the plurality of items is flagged as being lost or stolen.

In certain exemplary embodiments of this invention, an electronic registration system is provided. A centralized electronic registration (ER) database is connected to a network, with the ER database being configured to receive item-level data for a plurality of items from a plurality of touchpoints in a global sales system and being configured to update the item-level data as items in said plurality of items progress through respective product lifecycles. Detection programmed logic circuitry is configured to detect any (a) occurrences of unexpected events pertaining to the items in the ER database, and (b) flagging of items in the ER database as being lost or stolen. Notification programmed logic circuitry is configured to notify stakeholders in dependence on output from the detection programmed logic circuitry.

According to certain exemplary embodiments, item-level data may be received from manufacturers, retailers, logistics providers, and/or the like. In this regard, the item-level data may be received from EPC/RFID readers, barcode readers, manual key entry systems, etc., which may be connected to respective computer systems of these and/or other parties.

According to certain exemplary embodiments, the updating may be performed each time an item is transferred from a manufacturer to a logistics provider, a logistics provider to a retailer, and a retailer to a consumer. According to certain exemplary embodiments, the updating also may be performed each time a consumer initiates a warranty or return request for an item.

In certain exemplary embodiments, the unexpected event may be any one or more of the following events: a sold item being presented for sale after an original sale date associated with the item, an item marked as lost or stolen being presented for sale, and an item marked as lost or stolen being presented for return.

In certain exemplary embodiments, subscription requests may be received from stakeholders, with each said subscription request identifying an item or group of items to be monitored for a specified unexpected event. Notifications may be sent in dependence on the received subscription requests and/or the predefined rules. In certain exemplary embodiments, predefined rules may be provided for specifying, for example, that an entity that provided the item-level data for the item is to be notified and/or that a last entity and a next entity in the chain-of-custody is to be notified, when the unexpected event is detected and when the particular item is flagged.

Programmed logic circuitry may include, for example, any suitable combination of hardware, software, firmware, and/or the like. A computer-readable storage medium may include, for example, a disk, CD-ROM, hard drive, and/or the like.

The exemplary embodiments, aspect, and advantages described herein may be used in any suitable combination or sub-combination such that it is possible to obtain yet further embodiments of the instant invention.

### BRIEF DESCRIPTION OF THE DRAWINGS

Aspects and characteristics of the exemplary illustrative non-limiting implementations will become apparent from the following detailed description of exemplary implementations, when read in view of the accompanying drawings, in which:

FIG. 1 is an exemplary schematic block diagram illustrating an example of an overall exemplary electronic registration system;

FIG. 2 is an exemplary flowchart illustrating a series of steps that may be performed at a point of sale for registering a product transaction;

FIG. 3 illustrates an exemplary transaction receipt which reflects a product serial number and a transaction date;

FIG. 4 illustrates an exemplary flowchart for an electronic data interface between a product retailer and a product manufacturer;

FIG. 5 is an exemplary block diagram of an exemplary database system;

FIG. 6 illustrates an exemplary flowchart for product registration before the product is placed into commerce;

FIG. 7 illustrates an exemplary flowchart for a product status update when a product is stolen, sold, discovered missing, etc.;

FIG. 8A illustrates an exemplary flowchart for a product check;

FIG. 8B shows an exemplary process for notifying asset protection under the exemplary system shown in FIG. 8A;

FIG. 9 shows an exemplary process for verifying ownership of a recovered item based on serial number clustering;

FIG. 10 is an exemplary schematic diagram providing an overview of the active notification techniques of certain exemplary embodiments;

FIG. 11 is an illustrative schematic view of how system components may be oriented with respect to a centralized ER database in accordance with an exemplary embodiment;

FIG. 12 is another illustrative schematic view of how system components may be oriented with respect to a centralized ER database in accordance with an exemplary embodiment;

FIG. 13 is an illustrative schematic view showing how certain components may access and/or retrieve data from a centralized ER database in accordance with an exemplary embodiment; and

FIG. 14 is an exemplary flowchart for a maintaining a centralized ER database and sending out notifications.

### DETAILED DESCRIPTION

It will be recognized by those of ordinary skill that modification, extensions and changes to the disclosed exemplary implementations may be made without departing from the scope and spirit of the invention. In short, the present invention is not limited to the particular forms disclosed herein.

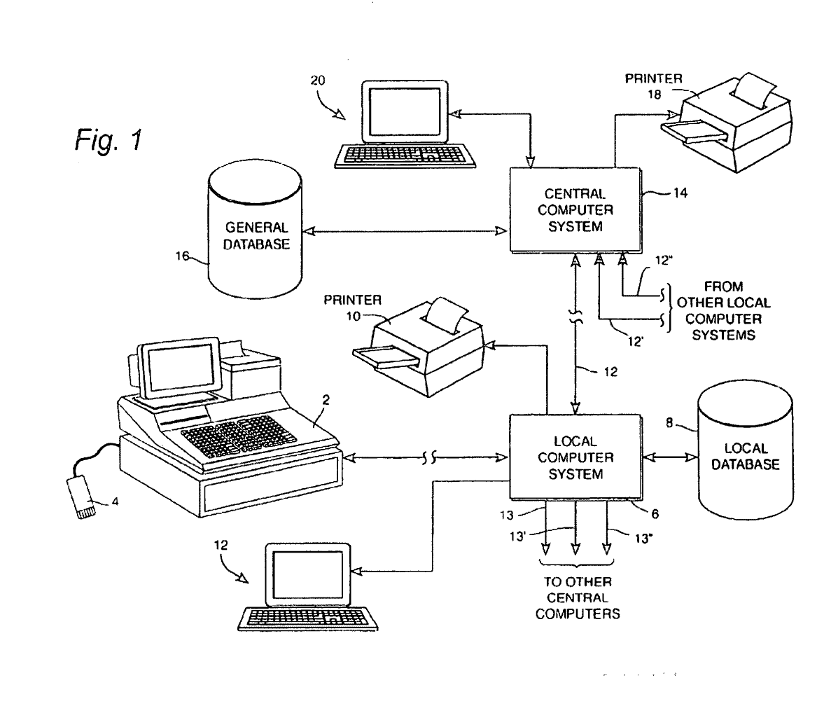

An example of an electronic registration system is illustrated in FIG. 1. Briefly, the example system may include a point of sale register 2 and an associated bar code scanner 4. The register 2 may be connected with a local computer system 6 in a suitable manner. For example, the register 2 may be “hard-wired” to the local computer system 6. Alternatively, the register 2 and the local computer system 6 may communicate, for example, through modems and telephone lines, or over radio communication channels. Any appropriate communication channel may be used.

In certain situations (e.g., single store retailers), the local computer system 6 may be located in proximity to the register 2. For large chain stores, however, the local retailer computer 6 may be situated at a central location with links to the registers 2 at individual stores. The particular arrangement will depend on the preferences and circumstances of the specific retailer.

The local retailer computer system may include an associated local database 8 for storing registration information. Additionally, a local printer 10 and an operator terminal 12 may be provided. The operator terminal may be used, for example, by a store clerk upon return of merchandise to locate pertinent sales information in the local database 8. The printer 10 may be used to produce hard copies of end-of-day sales reports and the like.

In one exemplary illustrative non-limiting implementation, a communication channel 12 is provided between the retailer computer system 6 and a central computer system 14. The central computer system may, for example, be a manufacturer computer system. Alternatively, the central system could, for example, be a regional computer system for a large chain of stores, a distributor computer system, or the like. It should be appreciated that the term communication channel is used herein in its broadest sense, and includes any suitable technique for passing electronic information between systems. Such suitable techniques include, for example, electronic links via modem, radio links, wireless communication, or even communications established by physically transporting a recording medium, such as a magnetic disk, magnetic tape, or optical disk, from one system to the other.

A general database 16 may be associated with the central computer system 14 for storing transaction information from a plurality of retailer computer systems 6. Additionally, a printer 18 and an operator terminal 20 may be included with the central computer system 14.

As illustrated in FIG. 1, the central computer system 14 may have a number of additional communications links 12′, 12″, etc. for receiving information from other local computer systems. Thus, for example, a manufacturer may receive information from a number of different retailers. Additionally, the local computer system 6 may include a number of additional communication channels 13, 13′, 13″, etc. for connecting with other central computer systems. Accordingly, an individual retailer can electronically register products from a number of different manufacturers.

For convenience, the multiple communication channels in FIG. 1 are illustrated with separate lines. It should be noted, however, that separate lines are not necessary. For example, the local computer system 6 more likely would have a single communications line, and connection with the particular central computer system 14 would be made through a modem by dialing the appropriate telephone number.

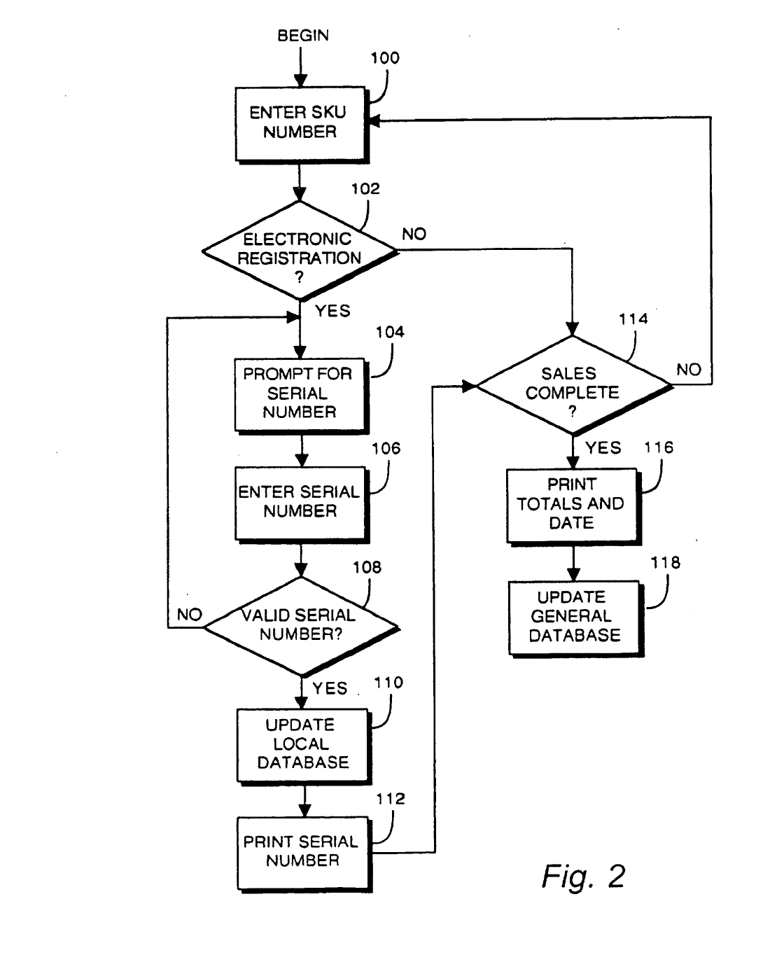

An example of the operation of the system illustrated in FIG. 1 is described in connection with FIGS. 2-4. Referring now to FIG. 2, the electronic registration process begins when a customer brings merchandise to the register for check out. The sales clerk enters the SKU number which identifies the type of product involved in the transaction (e.g., Super Nintendo Entertainment System, Game Boy, Virtual Boy, Nintendo N64, etc.) by, for example, scanning a UPC product code included on the product packaging (100). Of course, key entry, transmission of EPC, or another technique for entering the SKU number may be used.

Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired (102). If so, the store associate is prompted to enter the serial number, or some other unique identifier, of the individual item (104). Possible unique identifiers include, but are not limited to, a combination of a UPC (EAN, JAN) number and/or Brand Name and/or Model number, plus a serial number, or an Electronic Product Code (EPC) provided from a Radio Frequency ID (RFID), etc.

The serial number, or some other unique identifier, may be entered (106), for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as one exemplary form of individual production identification information.

Once the serial number is entered, a check may be made to ensure that the serial number is valid (108). See, for example, U.S. Pat. No. 6,947,941. If not, control returns to 104, and the store associate is again prompted to enter the serial number. This is repeated until a valid serial number is obtained. It may be desirable to provide store managers with the ability to override the requirement to enter a serial number in a limited number of situations. If such an ability is given, however, the overrides should be monitored to ensure the ability is not abused. This may be done, for example, by generating a periodic report listing all overrides by individual managers, or a real-time (or substantially real-time), immediate notification based on designated business rules (with transmission to PDA, cell phone, etc.).

Several different techniques may be used to evaluate and verify the validity of the serial number. In one technique, a check digit is added to the serial number. Such a technique may utilize a predetermined mathematical algorithm performed on the digits of the serial number. If the result of the predetermined mathematical algorithm is equal to the check digit, the validity of the serial number is verified.

An example of a check digit technique will be described in connection with an eight-digit serial number. A predetermined mathematical algorithm associated with the check digit may be to multiply the sum of the first four digits of the serial number of by two (2), multiply the sum of the last four digits by three (3), and sum the resulting products. This may be expressed in equation form as:

2(N.sub.1+N.sub.2+N.sub.3+N.sub.4)+3(N.sub.5+N.sub.6+N.sub.7+N.sub.8)

where N.sub.1 is the first digit of the serial number, N.sub.2 is the second digit of the serial number, and so on. The check digit may then be taken as the least significant digit of the result. Thus, for a serial number 22312313, the result of the predetermined mathematical algorithm is 2*(2+2+3+1)+3*(2+3+1+3)=16+27=43. The check digit is the least significant digit; that is the check digit is 3. Accordingly, the number appearing on the product would be 223123133, wherein the last digit is the check digit. For serial number 10532641, the check digit is 7[2*(1+0+5+3)+3*(2+6+4+1)=18+39=57], and the number appearing on the product would be 105326417.

The particular mathematical algorithm used in connection with the check digit is not critical. Any predetermined mathematical algorithm may be used to obtain the check digit. Indeed, for added security, it is possible to utilize more than one check digit, wherein each check digit is calculated by a different mathematical algorithm. Whatever mathematical algorithm is used, however, it is desirable to minimize the number of individuals with knowledge of the specific operation to reduce the risk of false serial numbers being generated.

Once the serial number is verified (108), a local database may be updated with the serial number information and any other necessary or desired information (110). This information might include the price paid, the store associate responsible for the sale, the date of the transaction, transaction number, and the like.

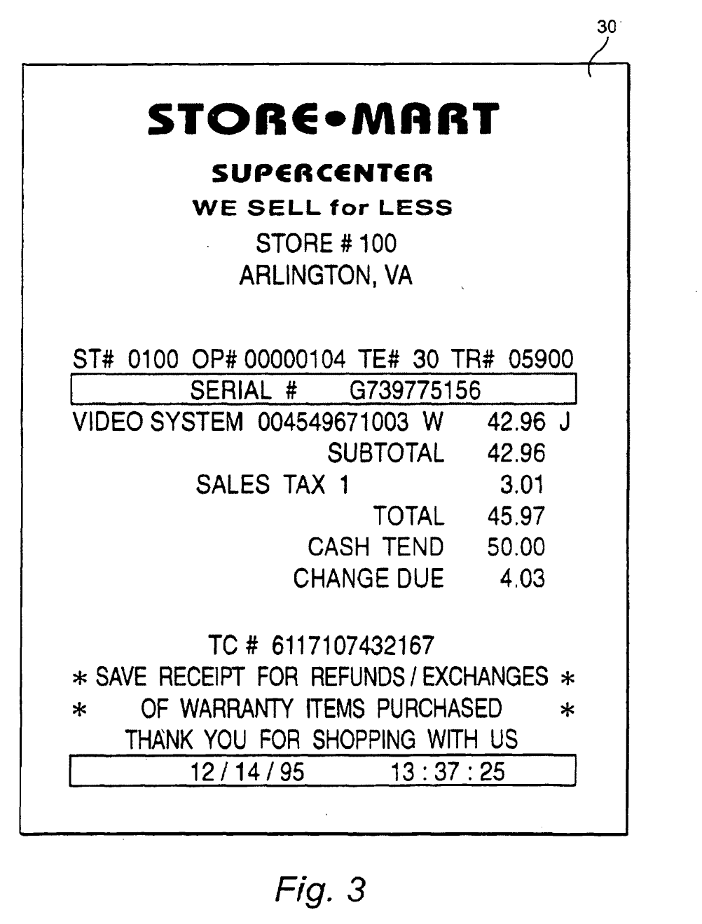

The serial number of the individual product may be printed (112) as part of a written customer transaction receipt. As shown in the sample sales receipt 30 of FIG. 3, the serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction may appear anywhere on the receipt. In the example operation illustrated in FIG. 2 and the sample sales receipt of FIG. 3, the date is printed at the end of the sales receipt 30 (116). For ease of viewing, the serial number and date on the sample receipt 30 are indicated by boxes. If desired, an actual printed receipt may also have such information highlighted, for example, by a different color ink.

Turning back to the example operation illustrated in FIG. 2, after the serial number is printed, a check is made to determine whether sales are complete (114). Ordinarily, this will be based on the store associate hitting a TOTAL button on the cash register. If sales are not complete, control returns to 100 for entry of a SKU number for the next product. Otherwise, sales'totals are calculated and printed on the receipt along with the current date (116). Thereafter, the central computer system may be contacted and the general database may be updated.

It should be emphasized that the operation illustrated in FIG. 2 is merely exemplary, and that the steps need not be performed in the particular order shown. For example, all print operations and database updates can take place after sales are completed. Additionally, it is not necessary to update the databases on an item-by-item basis. Indeed, efficiency and speed in updating the general database may be increased by batching transactions in groups of, for example, fifteen transactions.

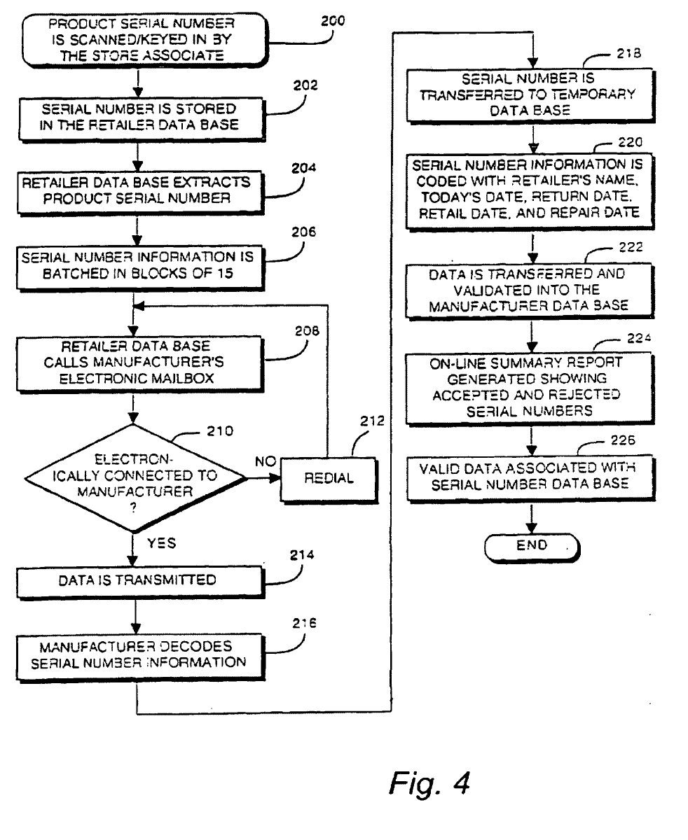

An example technique for interfacing the local computer system 6 to the central computer system 14 is illustrated in FIG. 4. Product serial numbers are scanned or keyed in by a store associate (200) and stored with associated information in the local database (202) using an operation such as discussed in connection with FIG. 2. Thereafter, the local computer system 6 extracts the serial number information from the database (204) and batches the information in blocks of fifteen (206). It will be appreciated, however, that batches may be provided in different sizes in different exemplary embodiments, and/or that transmissions may be made on an individual item-by-item basis. The operations represented by 204 and 206 may be performed periodically, for example, daily.

Once the serial number information is captured and/or properly batched (206), the local computer system 6, in this case a retailer system, may connect with the general computer system 14, in this case a manufacturer's computer system, to make an electronic link to an electronic mailbox set up for that particular retailer (208). A separate electronic mailbox may be set up for each manufacturer account. The connection is tested (210) and, if the connection is not properly established, the retailer computer system 6 may reconnect (e.g., redial) (212) until a proper connection is established. At that point, data is transmitted (214) to the electronic mailbox. Batching the information increases transmission speed and, therefore, reduces data transmission times.

Data communications between the retailer system and the manufacturer system may use a conventional communications format. For example, the computer systems may be equipped with an EDI Translator capable of using the Standard 140 file format established by the EIA. The Standard 140 file format is specifically designed to extract product registration information. A typical transmission would begin with a Transaction Set Header to indicate the start of a transaction and to assign a control number. This would be followed by a Beginning Segment for Product Registration which indicates the beginning of a product registration transaction set and transmits identifying numbers, dates and times. The identifying numbers may include a Purpose Code to identify the type of registration (e.g., original sale or return to stock) and a Reference Number assigned by the user for the particular transaction. Next, a Name segment is transmitted to identify the user by type of organization, name and identifier code. The identifier code may indicate an organizational entity, a physical location, or an individual.

If desired, additional identifying segments such as an Address Information segment and a Geographic Location segment may be transmitted. The address information might include, for example, a street number and name for the individual store. The geographic location information might include the city name, a state or province code as defined by an appropriate Government agency, a postal code (e.g., a zip code in the United States), and a country code.

Following any desired additional identifying segments, specific item identification information (e.g., serial numbers) may be transmitted along with a textual description of the product if desired. Information identifying the individual store that sold the particular item may be associated with the information for that item. Appropriate dividers would be provided to separate the information for the respective individual items. After the individual item information has been transmitted completely, a Transaction Set Trailer segment may be transmitted to indicate the end of the transaction set and provide the count of transmitted segments. It will be appreciated that a serial number may be printed prior to or after the conclusion of the transaction depending, for example, on the capabilities of the system.

Returning now to FIG. 4, the manufacturer computer system 14 decodes the serial number information received from the retailer (216). The decoded serial number information may initially be stored in a temporary database (218) and, in this exemplary implementation, the serial number information is encoded with the retailer's name, the registration date, the sale date, the last date on which returns will be accepted, and the last date for warranty repairs (220). The individual serial numbers may then be validated using the check digit technique discussed above, and the data is transferred to the manufacturer's general database (222).

Following validation of the serial numbers, an on-line summary report may be generated which lists all accepted and rejected serial numbers (224). The valid data may then be stored in the manufacturer's national serial number database.

The summary report provided in 224 may provide one tool for the manufacturer to locate trouble spots caused, for instance, by malfunctioning retailer systems or attempted fraud. Additional monitoring reports may also be generated as desired. For example, the serial number pass/fail ratio for all returns by a particular retailer over a given time period may be reported, duplicate serial numbers may be located and listed, previously registered serial numbers may be flagged, and cross-references may be made between the registration date and the date the product was returned to the manufacturer. Such reports can be used by the manufacturer to monitor retailer returns for possible problems or abuse.

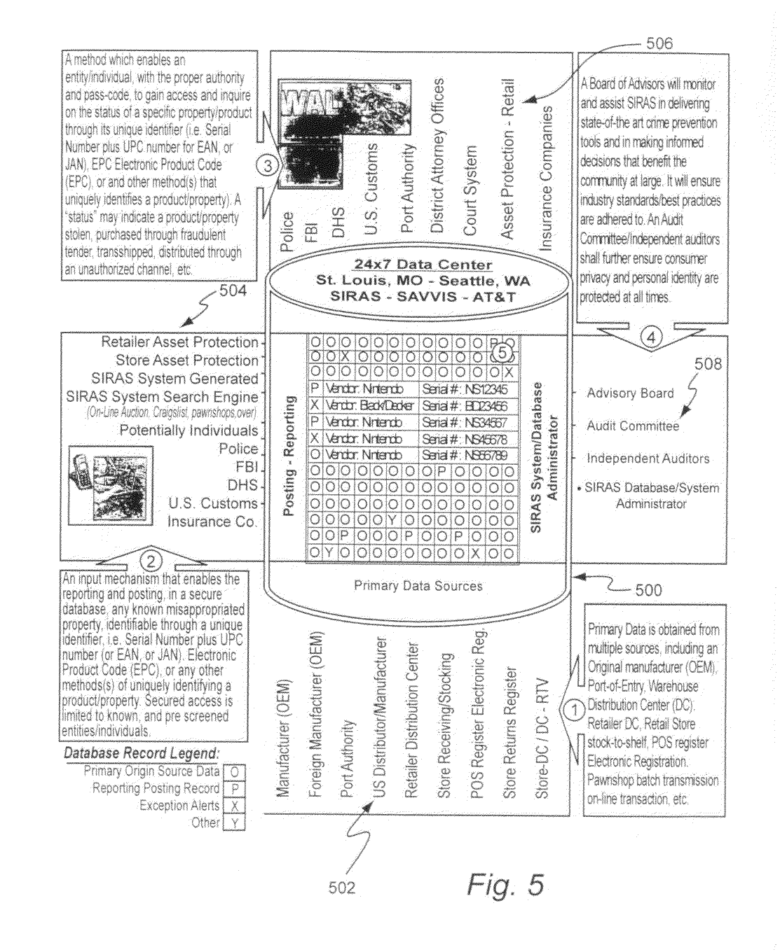

FIG. 5 shows an exemplary illustrative block diagram of a crime prevention database system in which the registration system is employed. The database (500) contains a comprehensive list of all the relevant stored information. Initially, to fill the database (500), multiple sources, such as OEMs, Port Authorities, Distributors, Store Receiving Systems, POS Registration Systems, etc, (502) all are capable of registering the products to the database. For example, if a manufacturer registers the product, the product may, at that point, be flagged as having been shipped from manufacturing. Then the registration may be updated by a distributor, so the product is now flagged as being at that distributor. The same product registration may be updated again upon arrival in the store. With such a comprehensive monitoring system, it is easy to track a product all the way from manufacture to point of sale. This helps aid in inventory loss prevention, and can be useful in other situations, to prove, for example, a chain of possession from manufacturer to retailer. Then, if the product is legitimately sold, its registration can once again be updated in the system and flagged as sold.

If a product is purchased through fraud, such as using a fake or stolen credit card, gift card, debit card, etc., fraud victim(s) (504) can report the product as “stolen,” “fraud,” or flag the product with some other appropriate identifier. Stores can use this to track missing inventory, and they can then quickly determine if a return is legitimate, or if someone is trying to return stolen goods. Online auction sellers could also use similar asset protection. If someone purchased a good from another, the shipper could register the good before shipment. If the payment never arrived, the shipper could flag the registered good as “stolen” and at least have a means of keep some tabs on the good.

Individuals might also have other uses for the system. If someone lost an expensive cell-phone, watch, PDA, etc., and had pre-registered the device, then they could easily update the status of that product as missing/stolen/lost. If the product later turned up (e.g., someone tried to activate the phone, or sell the watch in a pawn shop), the proper owner or appropriate investigative agency could be informed.

Other parties which may wish to register and update registries of goods include, but are not limited to, police, FBI, DHS, U.S. Customs, insurance companies, other private businesses, etc.

In addition to registering products and changing the registration status, parties (506) could also be interested in running queries on a database to check the status of particular goods. This has obvious use to law enforcement. If the police raid a suspected criminal's house and find nine TVs, they can quickly query the database to see if any retailers or consumers have reported those serial numbers as stolen. They can also flag the registrations for the TVs with some indicia that the TVs are in police custody, so that if someone later reports one as having been stolen, the person knows where to retrieve the TV.

Stores can also report inventory as stolen, fraudulently purchased, etc. If someone brings a product back for a return, and it is flagged as being associated with fraud or theft, an authorized store representative can make a decision as to whether or not to contact security or law enforcement. Also, if the product is still flagged as being on the shelf, the store can quickly know that someone has simply taken a product from the shelf and is trying to return it. In an implementation where the system is capable of being accessed at the point of return, there is little delay in which a criminal may escape or a busy sales associate may inadvertently accept a bad return.

Customs and Port Authorities could scan high price goods to check that those goods were not registered as stolen. This scan could also update the status of the goods so that they showed as having entered the country at a certain location. Pawn shops could check products before purchasing, to ensure they are not buying stolen goods. Insurance companies could require registration of expensive goods, and then check to make sure those goods hadn't transferred to another owner if the goods were reported as destroyed or stolen. Insurance companies could also use the system to attempt to recover any goods that were reported as stolen.

Additionally, access for reporting, updating and checking the database may be limited to authorized users, to ensure that records are not compromised. Security for various levels can depend on the needs of the particular system and the class of user allowed to access a facet of the system. Further, it may be desirable to allow people checking the system for the information associated with a particular ID to peruse the entire system, since they may not know which section/manufacturer/retailer/etc. under which the item is located. On the other hand, if a manufacturer, such as Nintendo, wishes to register products, they may only be able to register, update and modify entries for Nintendo. Their access to other manufacturer's sections may be precluded. It may also be desirable to prescreen entities before giving access to any/all sections.

Numerous other entities and uses exist for this system, those listed herein are given as examples only.

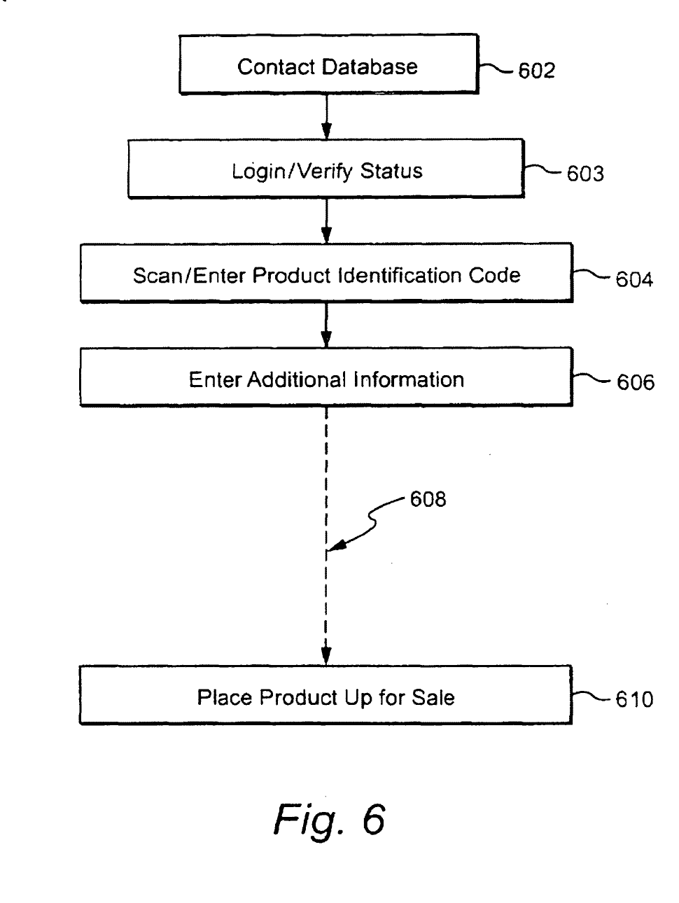

FIG. 6 shows an exemplary registration process for initial registration of the good. According to this exemplary illustrative non-limiting implementation, at some point from manufacture to retail, the database is first contacted (602). After the entity contacting the database has established that they are authorized for a registration transaction (603), they enter a unique ID code associated with the particular produce (604). This can be a serial number, or a combination of some more generic number like a UPC plus another unique identifier. Any code/combination which will uniquely identify the product will suffice. This code can be scanned in, hand-entered, or input or received through any suitable means.

The entity is then given the option to enter additional information (606). For example, if the manufacturer did the initial registration, then the additional information might consist of a manufacturer's name, location, and, if known, the distributor/retailer to which the product was headed. Similar and/or additional information can be added at a distributor, retail, or any other level at which the product is registered.

Then, a series of transfers/updates may or may not occur (608) before the product is placed onto a shelf for sale (610). For example, the product status may be updated at a distributor and when it arrives at a retailer. These updates might consist of each possessor between the manufacturer and the retailer performing steps 602, 603, 604, and/or 606. Additional suitable actions could also be taken.

With status that is updated at each step, it is easy for a product's last known whereabouts to be identified if the product ends up missing. If the product passed, for example, through two distribution centers and a regional HQ without being updated before arriving at the store, and was later determined to be missing, then it might be hard to track down. A distribution chain which regularly records product status updates at each step would show exactly where an update last did not occur, and thus narrow down the area of loss to a particular transfer or location.

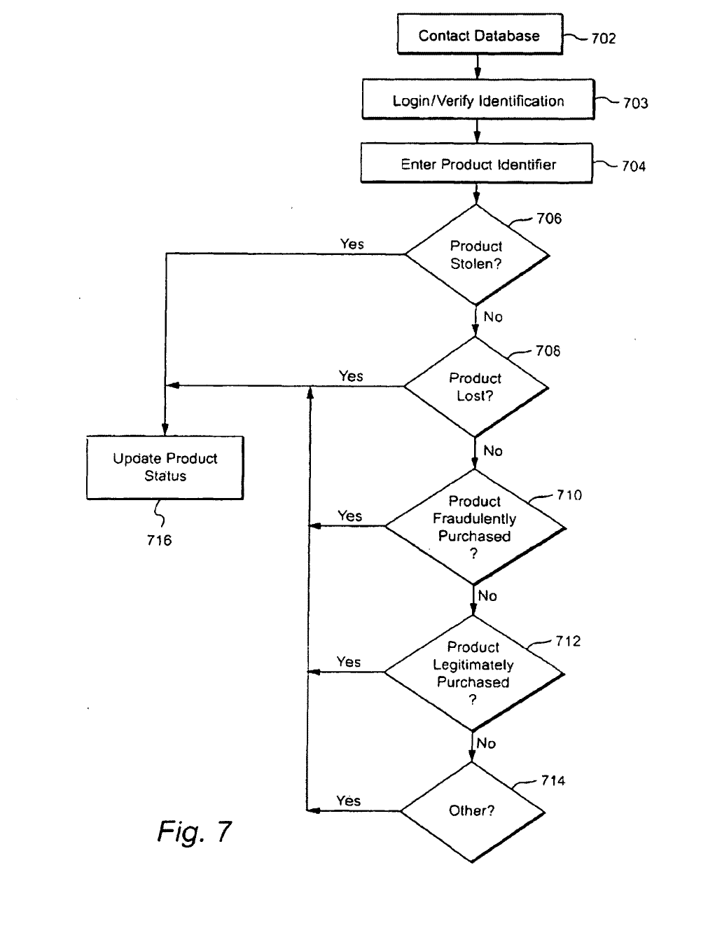

FIG. 7 shows an exemplary access flow for a product database if the status of a product is entered or changed. Again the reporting entity must first contact the database (702) and gain authorization to access the record updates (703). The entity must then input some sort of product identifier (704). Since a product may be lost or stolen, this may not always be the same base identifier stored with the product. For example, if the product was stolen, then the store may provide information such as date of delivery, UPC codes of similar products, last known date in inventory, etc. If the database system searched UPC codes and found ten entries, three of which correlated to legitimately sold goods, and seven which were supposed to still be in inventory, then the store could determine the serial numbers of the stolen product(s) based on the numbers remaining. If only five were left on the shelves, then the two serial numbers not correlating to one of the five remaining products could be flagged as stolen. Other indicia could be used as well to narrow down the ID of a missing product, such as color or other identifying characteristics of the product (e.g., if the store originally had three blue recliners, and now only has two blue recliners).

Or, for example, if a fraudulent purchase was discovered, then the serial number associated with that purchase (initially flagged as a legitimate purchase) could be switched to indicate a fraudulent purchase. If a box is discovered as open and empty, the store may use the UPC and serial number on the packaging that matches with the product serial number or some other identifying method to flag the product as lost or missing. If the product is later discovered, repackaged and sold, then the lost or missing status may be updated at the point of sale to reflect a legitimate sale of that item.

Once the product has been identified in some fashion, the entity reports whether the product was stolen (706), lost (708), fraudulently purchased (710), legitimately purchased (712) or some other (714) status update. The product status is then updated (716). It may be desirable to allow the most recent update to overwrite any previous “present status” indicator for a product. The database can keep a list of all phases of status for a product, but if a quick check is needed then the present status should probably correspond to the most recent update. For example, a product seemingly legitimately purchased may only later be discovered as a fraudulent purchase, and it would be desirable to have the fraudulent purchase flag be the presently associated status. Or a missing item flagged as such may be discovered and sold, then the presently associated status should be that of a legitimate purchase. Additionally, if consumers as well as retailers used the database, then a consumer reporting a good as stolen would want that to be the status, as opposed to the legitimate sale status provided when the consumer first purchased the good. As long as reasonable security measures are taken, criminals should not be able to mislabel the present status of goods in order to aid in perpetration of a crime. It may also, however, be desirable to maintain a record of all status flags associated with a particular item, so that backgrounds of items and possession histories of items can be established if need be.

The steps presented in this and other examples do not necessarily need to be performed in the order presented herein, but are merely shown in such form for exemplary purposes. Nor are all steps necessary, nor is the list of steps exhaustive. This and other flowcharts merely show one exemplary procedure for performing the described process.

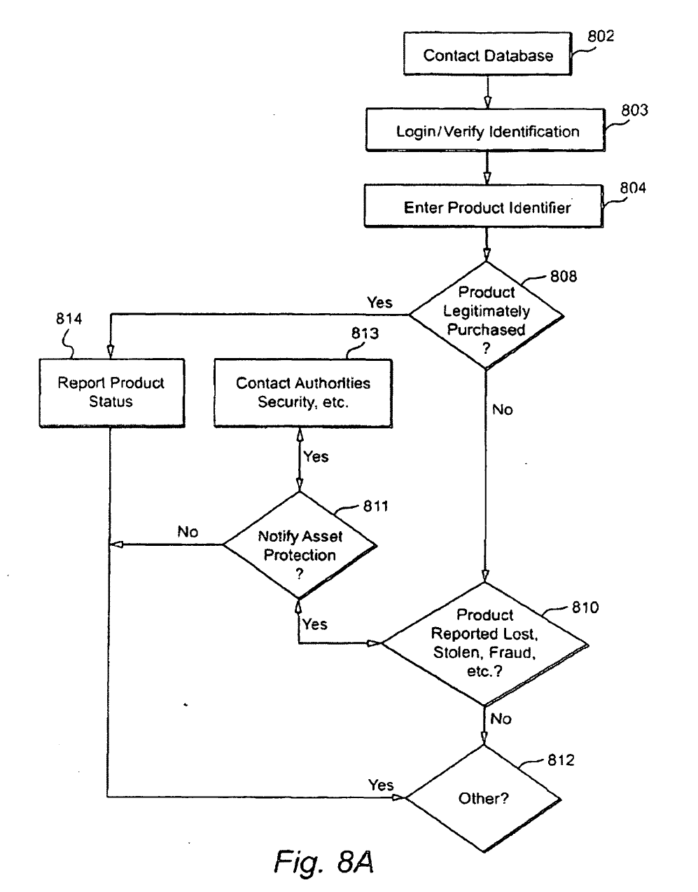

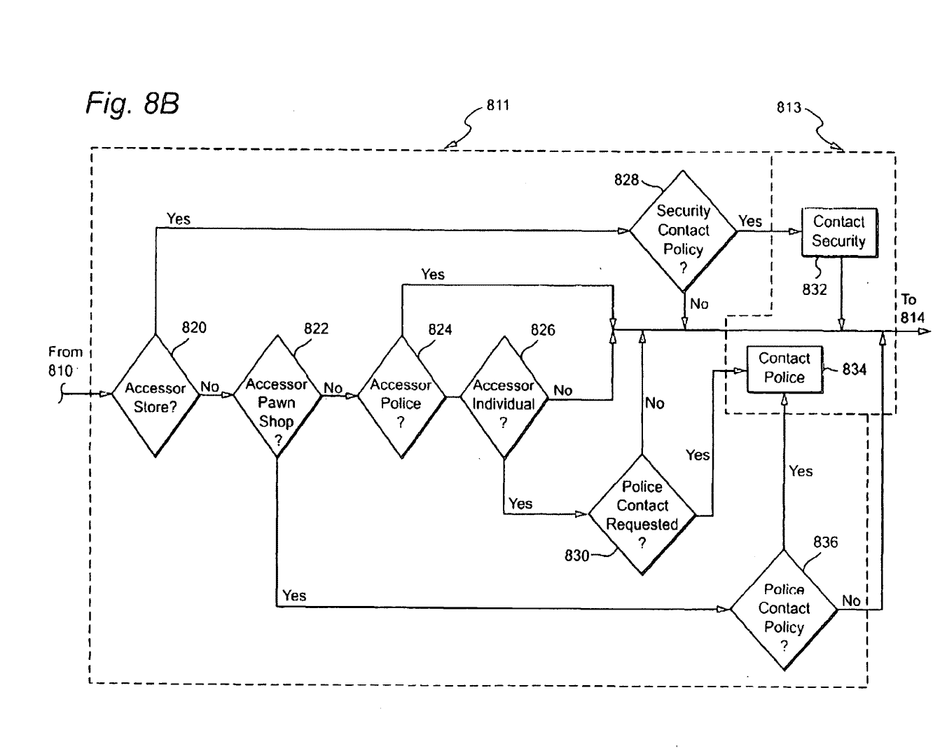

FIG. 8A shows an example of a database access made by an entity checking the present status of goods. As before, the checking entity must first contact the database (802) and establish a right to access the contents (803). Then, the checking entity enters a unique ID code associated with the product (804). Presumably, in this instance, the checking entity would know the ID code because in the checking situations the product would typically be on hand. For example, this could be police checking some allegedly stolen goods, a pawn shop checking to see if goods were stolen before purchase, or a store checking the status of a return.

Even though the above examples of checking entities involve retail/government, there is consumer application for the checking as well. If a product was for sale on, for example, an online auction site, then a seller could post a picture of the serial number. Possible buyers could then access the database to determine that the product was not stolen. The website might even require registration to cut down on customer dissatisfaction and/or incidences of stolen goods changing hands. For example, a website may require a seller to key in an identifier before listing a good. The website can then check the database, and as long as the good is legally possessed, allow the good to be listed.

Certain states also require pawn shops to register goods. Pawn shops could use the database as an easy way to register and check the status of all goods which they handle.

Even courts could benefit from the database. If a defendant claims to own an item alleged to be stolen, the court could compare purchase evidence presented by the defendant with the actual information stored in the database.

All these examples of potential uses are merely exemplary, and are not intended to limit the invention in any way.

Once the checking entity has identified the product to be checked, the system checks if the product was legitimately purchased (808), reported stolen, lost, fraudulently procured, etc. (810), or has any other associated status (812). The present status of the product is then reported back to the checking entity (814). In this exemplary implementation, if the status of lost/stolen/fraudulently procured comes up, then a check is made to see if some form of asset protection should be contacted (811). If so, then the proper authorities are contacted (813) and the checker is notified of the product status. It will be appreciated that the process may effectively start when a person contacts the authorities (813), who may then notify asset protection (811) to report a product lost, stolen, the subject of attempted or suspected fraud (810), etc.

FIG. 8B shows an exemplary process for notifying asset protection under the exemplary system shown in FIG. 8A. It may be desirable to base a notification policy on the particular entity checking the database. For example, stores may want security called, pawnshops may want (or be required) to have the police called, and the police may not want anyone called. In this exemplary illustrative non-limiting implementation, the system checks to see if the accessor is a store (820), a pawn shop (822), the police (824), or an individual (826). Such a check can be performed based on the accessor's ID or any other suitable criteria.

If the accessor was a store, then there may be an additional check to see if the store automatically calls security (828). For example, some stores may wish to implement a backup system, or rescan an item, before having security come forward and arrest the individual. Other stores may want security called instantly (832).

If the accessor was a pawnshop, the system similarly checks to see if police should be immediately contacted (836). Perhaps a state would require immediate contact of the police if a stolen item was scanned by a pawn shop. This can also potentially be a safe way for a pawn shop owner to contact the police without any overt action to notify a criminal. If the police need to be contacted, the system can contact them (834).

On the other hand, if police are the ones accessing the system, then they don't need to have the system place another call to the police, as they already know about the particular item for which they have called.

Individuals may be given an option to contact the police (830). For example, if someone buys an item from another person online and attempts to register it and finds out it was stolen, they may be asked if they wish to contact the authorities (830). If they select yes, then the system can contact the police (834).

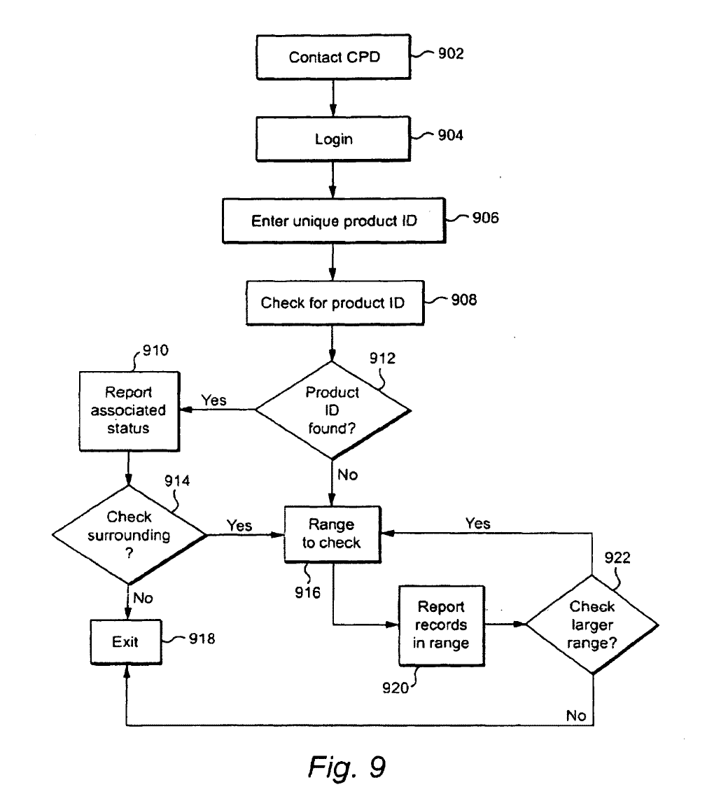

FIG. 9 shows another exemplary illustrative non-limiting use for the CPD. In the exemplary process of FIG. 9, the CPD is used to check the serial numbers surrounding a number corresponding to an item recovered by the police.

As before, the accessor contacts the CPD (902) and enters some verification information to login (904). Next, the accessor enters a unique product ID associated with the item in question (906). In the example associated with this exemplary process, the police would possibly be the police. They could access the database, and input the serial number associated with a product which they had just recovered from a thief.

Next, the database will check for a product corresponding to the entered ID (908). Depending on when or if a particular product was registered, it may or may not have some status associated with it. For example, if the manufacturer registered the products, then the database may have that registration, even if the store seeking to recover the product never registered the product.

The exemplary process then branches based on whether or not a product ID was found (912). If there is a corresponding ID, then the status associated with the particular product is reported back (910). If there is not a corresponding ID, then the accessor is asked to provide a range to check (916). In this exemplary implementation, the range is a number of products on either side of the stored serial number. Other criteria could also be used for the search and, in certain exemplary embodiments, entries around the specified range may also be checked.

Even if there is an associated status with the input serial number or other unique ID, the accessor still may want to do a range check. Consequently, the system, after reporting any found associated status (910), asks if the accessor would like to do a range check (914). If not, the program may exit (918).

One example of a situation in which a range check may still be desired, even if there is an associated status, is as follows: If a manufacturer such as, for example, Nintendo, registered all products at point of sale to distributors, then there might be an associated status corresponding to the fact that Nintendo sold the product. But, it may not indicate to whom the product was sold. In this case, a check would still be desired to try and determine to whom the particular product was sold.

After the accessor inputs a check range (916), the database reports back all serial numbers in that range and an associated status (920). For example, if a Nintendo DS were recovered and had a serial number of aa12300011, then a range of three might produce the following exemplary results:

| | |
|---|---|
| aa12300008 | Store X |
| aa12300009 | Store X |
| aa12300010 | Store X |
| aa12300011 | not found |
| aa12300012 | Store X |
| aa12300013 | Store X |
| aa12300014 | Store X |

This would show, with a high degree of probability, that the recovered product belonged to Store X.

If a larger range report is desired, the accessor can answer “yes” to the check larger range inquiry (922). At that point, the range entry (916) and reporting (920) steps would be repeated. If there was no desire to check a larger range, the process could exit (918).

The exemplary CPD can sort based on product type and then organize the serial numbers in order, making it able to recover a range of recorded serial numbers on either side of the product. Further, since many manufacturers palletize their products as they come off of the line, the serial numbers on a shipped palette are usually in numeric order. Thus, if a merchant buys a palette of goods, they will typically take possession of a set of sequentially numbered products.

The CPD of certain exemplary embodiments allows a product to be linked to a specific event. It will be appreciated that the event may be a crime, a person misplacing or losing the product, a product not being delivered or being misdelivered to a person or retailer, etc. This illustrative feature of the CPD advantageously enables a closed-loop system to be created, wherein the users are protected and one end, and law enforcement or other authorized personnel have visibility at the other end. It will be appreciated that users of the CPD may include, for example, manufacturers, retailers, customers, credit-card companies, insurance companies, law enforcement personnel, retail asset protection investigators, etc.

More particularly, in a first example implementation, a user can tag an item as stolen or missing in the CPD. If the user later finds the product (e.g., in the event that the product simply was misplaced and subsequently found by or otherwise returned to the user), the user can then “unflag” the product in the CPD. If, however, the item is flagged as stolen or missing and it is later discovered at a place where it should not be (e.g., in the event that it is found, confiscated, or otherwise obtained by the police, given to a pawnbroker, etc.), an the CPD can identify the product as having been lost or stolen and sometimes may even provide a lead to the rightful owner.

In a second example implementation, the CPD may help to detect that a product is missing before a retailer even recognizes it as missing, e.g., from a shipment from a manufacturer, from its shelves, etc. In the event that the product is misdelivered or stolen such that it never makes it into the retailer's store, or in the event that the product goes missing from the retailer without the retailer noticing, the product may be “found” before a protected user even knows to be on the lookout for the missing product. This functionality may be accomplished in certain exemplary embodiments by adding products to the CPD when the are shipped from the manufacturer to the retailer. For example, the CPD may be cross-referenced to determine if the product was ever “originally sold” from the retailer prior to a “resale,” e.g., at a pawnshop, auction house, or other location (which may even include another retail shop).

In certain exemplary embodiments a fraud reduction and product recovery system is provided. A database includes a plurality of product entries, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. Product checking programmed logic circuitry is configured to determine whether the product to be checked was legitimately acquired. The second interface is further configured to provide an indication to the second authorized user whether the product was legitimately acquired.

Each status identifier may indicate, for example, at least whether the associated product has been lost or stolen. Additionally or alternatively, each product entry may further include for example, first sale date, anticipated first sale location, actual first sale location, and/or other like fields. Additionally or alternatively, each product entry may further include an owner contact field that includes contact information for an owner of the product.

The first authorized user may be, for example, a manufacturer, retailer, customer, etc., whereas the second authorized user may be, for example, a person charged with law enforcement, a retail asset protection investigator, an auction house employee, a pawnshop employee, etc. The first interface may be accessible the first authorized user at a location remote from the database such as, for example, at a point-of-sale or via a home computer.

The checking programmed logic circuitry may be further configured to indicate whether the product to be checked was legitimately acquired by determining whether the first sale date field is prior to a date of an attempted purchase, by comparing the actual first sale location field to the anticipated first sale location field, etc.

Notifying programmed logic circuitry may be configured to notify law enforcement personnel when the checking programmed logic circuitry indicates that the product to be checked was not, or may not have been, legitimately acquired. Additionally or alternatively, notifying programmed logic circuitry may be configured to contact the owner of the product to be checked when the checking programmed logic circuitry indicates that the product to be checked was not, or may not have been, legitimately acquired.

The interfaces to the database may be, for example, computer-implemented user interfaces. In certain exemplary embodiments, the user interfaces may be provided through custom applications running locally on a computer with a suitable network connection, webpages accessible over a network (e.g., such as the Internet), etc. In certain exemplary embodiments, the interfaces may be at least partially automatically accessed. That is, in certain exemplary embodiments, the first interface may be automatically accessed and the database may be updated, e.g., when a customer purchases a product at a point-of-sale location or online. In such cases, information about the product (e.g., brand name, UPC or EPC, date or purchase, place of purchase, etc.) as well as information about the purchaser (e.g., name, contact information, etc.) may be gathered and stored to the database, e.g., by reading information about the product from a register and information about the purchaser from credit card information, from online forms, etc. In certain exemplary embodiments, the second interface may be automatically accessed, e.g., when a product is loaded for sale or actually sold by an online auction house, received or sold at a pawnshop, etc. Notifications or alerts may be generated to interrupt (e.g., place a temporary hold on or completely stop) a prospective sale.

In certain exemplary embodiments, in a fraud reduction and product recovery system, a method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

In certain exemplary embodiments, a computer-readable storage medium tangibly storing instructions for causing a computer to implement a fraud reduction and product recovery method is provided. A database including a plurality of product entries is maintained, with each product entry having at least a status field associated therewith. A first interface to the database is configured to enable a first authorized user to add product entries and/or change the status identifiers of the product entries. A second interface to the database is configured to enable a second authorized user to input information regarding a product to be checked against the database to determine whether it was legitimately acquired. It is determined whether the product to be checked was legitimately acquired. The second interface is further configured to provide an indication to the second authorized user whether the product was legitimately acquired.

As will be appreciated by those skilled in the art, it would be desirable to provide a single, centralized database resource for retailers, product manufacturers, and law enforcement personnel to research and locate information related to stolen goods. To date, there is no centralized database that houses this information and that can be used by multiple interest groups. Typically, each party maintains its own system to be used for its own purposes. For example, most retailers have their own databases. However, these retailer databases rarely include specifics down to the item-level and almost never include information regarding serial numbers. In any event, because there are so many different systems in use by so many different parties for so many different purposes, there is no common set of inputs and no vehicle to notify common stakeholders of common interests or criminal cases. Indeed, the inputs to the various systems tend to vary based on the interest group. Quality and consistency of data thus are issues when trying to integrate these and/or other systems.

EPC/RFID deployment at the item-specific level will require significant investment by product manufacturers and retailers. Part of the investment includes costs associated with affixing, tracking, and reading the tags. By using EPC/RFID technology at the item-level, however, manufacturers may achieve efficiencies throughout all “touchpoints” of a product's lifecycle, from conception to ultimate disposal, as the products may be quickly and accurately located and analyzed. During a particular product's lifecycle, it is likely that individual items will be identified as missing or stolen during transit or stolen during transport, storage, or after having been merchandised on store shelves. The absence of expected EPC/RFID tags may be viewed be an indicator of loss or theft, as may the identification of tags leaving locations without payment of authorization (e.g., shoplifting).

The assignee of the instant application currently provides a centralized database that includes the ability to track product movement functions including, for example, Shipped, Received, Inventoried, Missing, Stolen, etc. These statuses may be assigned during electronic registration at a retail point-of-sale location, in a warehouse via handheld scanner and batch upload, etc.

The introduction of EPC/RFID technology may further simplify the collection of products and their specific statuses. Indeed, as product suppliers and retailer adopt the use of EPC/RFID broadly at the item level, there is an opportunity to provide a central database to collect the EPC/RFID and/or product serial number identifier information related to goods that are missing or stolen, potentially at the item level, throughout the supply chain or within the retail marketplace. By collecting this data, the electronic registration database may exist as a centralized repository for stolen and missing items. The move to EPC/RFID also will help “homogenize” otherwise disparate data so that more uniform inputs may be provided to the centralized ER database.

Once item-level data is made available in the centralized ER database, certain exemplary embodiments may implement an “anticipatory” system that identifies suspect or fraudulent activities before, during, or after their occurrence. Interested parties may “subscribe” to the anticipatory system to receive feeds regarding these flagged activities. In other words, the centralized ER database may send outward notifications to systems and stakeholders involved in product recovery efforts. The systems and entities may include, for example, law enforcement agencies and related databases (e.g., the National Crime Information Center or NCIC, the Law Enforcement Retail Partnership Network or LERPnet, etc.), law enforcement case management and report management software systems, retailer loss prevention databases and software systems, online classified ad and/or auction databases (e.g., eBay, Craigslist, etc.), pawn databases (e.g., Leadsonline, BWI, etc.), and/or the like. In certain exemplary embodiments, stakeholders affiliated with a specific item or certain specific items may subscribe directly to notifications and/or alerts from the centralized ER database and its associated notification systems.

The centralized ER database may be the sole repository for stolen items, as reported by product manufacturers, retailers, and potentially other parties. The centralized nature advantageously may provide multiple interested parties (including law enforcement, etc.) with a single point of research, rather than several disparate systems.

Thus, it will be appreciated that in certain exemplary embodiments, automated notifications and subscription services may be connected to the ER database so that information about stolen items (e.g., EPC, SN, etc.) can be search for throughout all other “touchpoints” in the product system. The active nature of this system is advantageous for searching among and between, and/or on behalf of, interested parties including, for example, retailers, manufacturers, pawnshops, online auction houses, etc.

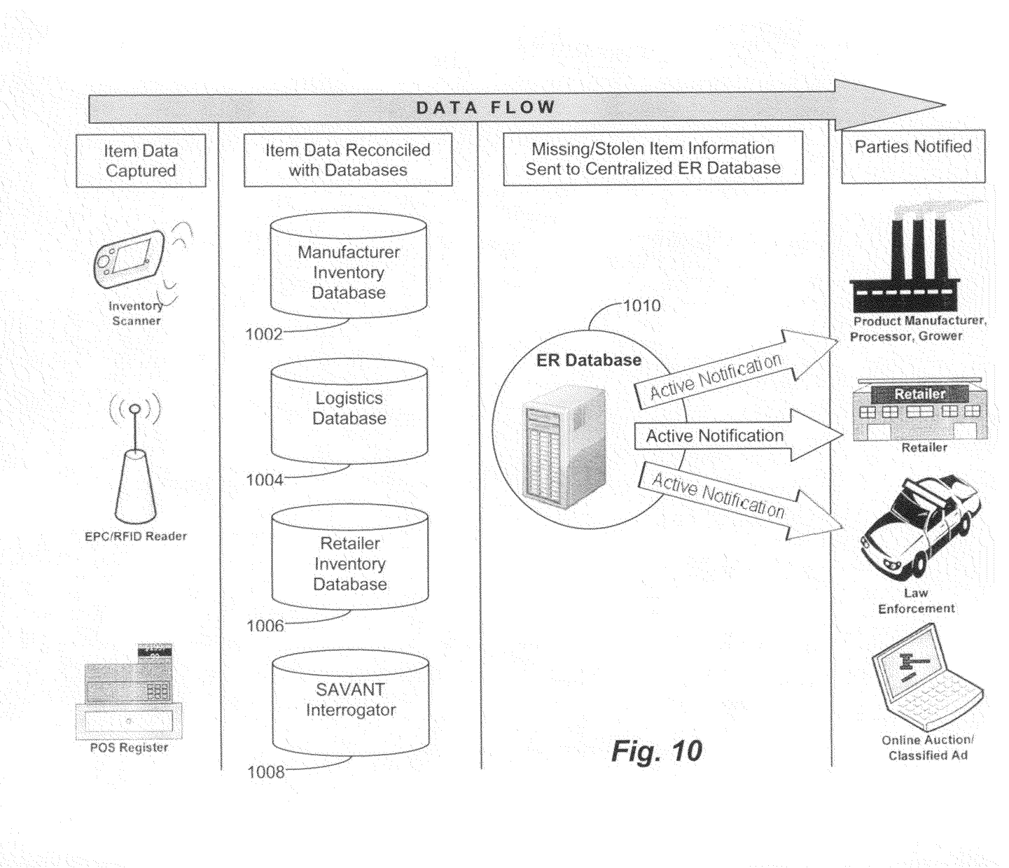

FIG. 10 is an exemplary schematic diagram providing an overview of the active notification techniques of certain exemplary embodiments. In FIG. 10, inventory scanners, EPC/RFID readers, POS registers, and/or the like may be used to capture unique item-level data. This information may be captured by product manufacturers, processors, growers, third-party logistics companies, retailers, and/or other parties. The unique item-level data is then passed on to one or more relevant databases including, for example, a manufacturer inventory database 1002, a logistics database 1004, a retailer inventor database 1006, etc. A Savant interrogator 1008 may be used to help convert EPC/RFID data to a format consumable by one or more of the other databases, as EPC/RFID data is not always easily understandable, e.g., to legacy systems. In simple terms, Savants help manage and move information that they may also help acquire from EPC/RFID tags. Savants often operate in a distributed architecture (e.g., so that software runs on different computers distributed through an organization, rather than from one central computer) and optionally may be organized in a hierarchical manner. Savants may help gather data from readers and pass on only relevant information to existing business applications, including the illustrative databases shown in FIG. 10. At this time, missing, stolen, counterfeit, B-, and/or other goods may be flagged in the individual databases, with or without the help of the Savant 1008. Additional details regarding the exemplary placement and operation of Savants are provided below.

The individual item data may be passed to the centralized ER database 1010. In certain exemplary embodiments, all individual item data may be passed to the centralized ER database 1010. However, in certain other exemplary embodiments, only that information corresponding to the types of suspect goods noted above may be passed to the centralized ER database 1010. The centralized ER database 1010 may compile and analyze data as it is received. Queries may be performed automatically, e.g., according to a predefined schedule, upon an authorized making a specific or general request (e.g., for a particular missing item, status of a product or class of items, etc.), when a new item or product is initially registered or subsequently registered, when an item is flagged as being stolen or missing, etc. Active notifications may generated and/or sent out at these and/or other times, as well.

The centralized ER database 1010 also may notify interested groups of missing/stolen items, e.g., using active processing, notification, and/or subscription protocols and/or services. Interested parties may include, for example, manufacturers, retailers, law enforcement agencies, online auction and/or classified ad services, etc. In certain exemplary embodiments, once a problem is detected by the centralized ER database 1010, a notification may be automatically sent to a predefined list of parties. Such a list may include, for example, the last party in the chain of custody, the next party that the item was supposed to go to, law enforcement personnel, and/or others. For example, if an item went missing somewhere between a manufacturer and a retailer, the manufacturer and retailer may be notified, as may the shipping or logistics company in charge of moving the item, together with law enforcement personnel. As another example, if an item was stolen from a retailer, that retailer and law enforcement personnel may be notified. In still another example, if an item was stolen from an individual but turned up at on online auction house, the individual from whom the product was stolen may be notified, along with the online auction house and law enforcement personnel. In certain exemplary embodiments, the person or entity originally entering the item information or the problem with the item may be notified in place of, or in addition, to those parties noted above. Of course, it will be appreciated that these are merely examples of groups that may be interested and how automatic notification lists may be organized and that other arrangements are possible and may be provided in connection with different embodiments of this invention.

In place of, or in addition to the use of predefined lists, parties may also subscribe to notifications. For example, a manufacturer may wish to know about every item that it makes that is stolen or lost. This information may be important for return/warranty purposes. As another example, a manufacturer or retailer may wish to subscribe to only those items having a value over a predetermined threshold (e.g., so-called “big ticket” items) or items that are particularly profitable, likely to go missing or be stolen, etc. As still another example, various law enforcement agencies may be interested in only certain types of products (e.g., items that may be used to make bombs, ammunition, controlled substances such as alcohol or tobacco, medications, etc.). A list of subscriptions may be stored in the ER database 1010. That list may include, for example, the party to be updated, the items or class of items that the party is interested in, the preferred contact method (e.g., email, file transfer, automated telephone call, text message, etc.), the time of contact (e.g., real time or substantially real time, daily, weekly, etc.), individual or batch notification, etc.

The system may be “anticipatory” in the sense that it may raise alarms and send notifications before problems are affirmatively flagged by parties. For example, the system may look for unexpected changes or inconsistencies. Such unexpected changes may include, for example, a lost or missing product being sold or returned, an item being sold or returned multiple times, multiple warranty requests for a single item, return authorizations past the contract period, etc. Rules for anticipating problems may be predefined and/or custom-programmed in certain exemplary embodiments of this invention. Furthermore, the rules for one entity (e.g., a manufacturer) need not necessarily be the same for another entity (e.g., a retailer or law enforcement agency). The rules may be tangibly stored in or at least be accessible by the centralized ER database, and a list of which party is interest in each rule also may be stored. Of course, an entity may define or redefine its rules and/or requested notifications/subscriptions at various times, and updates may be made appropriately.

It will be appreciated that the general flow described in connection with FIG. 10 is a departure from typical database systems that on their own are passive in nature. Indeed, certain exemplary embodiments advantageously provide an electronic registration database that may be used to actively automate the querying and notification process, e.g., to alert interested parties of stolen, missing, or otherwise suspect merchandise (e.g., using EPC, serial number, and/or other information) that may appear at other retailer locations, manufacturer return centers, online auction houses, classified listing sites, pawn shops, flea markets, and/pr other destinations, where the existence of the missing or stolen item is unintended.

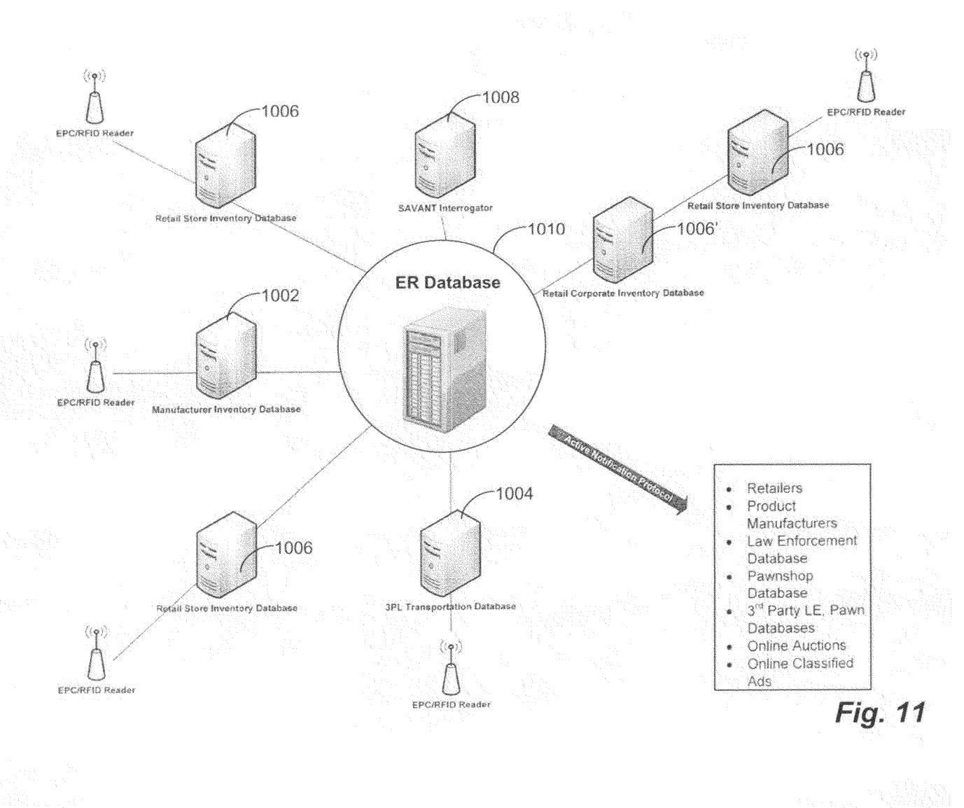

FIG. 11 is an illustrative schematic view of how system components may be oriented with respect to a centralized ER database in accordance with an exemplary embodiment. The ER database 1010 is shown as being in the center of the drawing, indicating that it can accept data from a number of different sources. For example, as indicated above, data may be obtained from manufacturers, retailers, logistics providers, and/or the like, e.g., using EPC/RFID readers or other data entry mechanisms provided at the locations. The raw data may be stored to an appropriate database, and data from the database and/or the location (directly or indirectly) may be provided to the centralized ER database 1010. In the FIG. 11 exemplary embodiment, this data is passed from the individual, disparate databases to the ER database 1010 directly. There is an exception to this general statement in the FIG. 11 exemplary embodiment, however, as a particular retail store inventory database 1006 is tied to a retail corporate inventor database which, for instance, may be a more centralized database storing item inventory information pertaining to a plurality of different retail locations.

With the possible aid of the Savant interrogator 1008 (which may be external to or incorporated into the ER database 1010 in different embodiments of this invention), such data may be stored in the ER database. That is, in certain exemplary embodiments, the ER database 1010 itself may be configured to read and interpret EPC/RFID data coming from the individual databases, and/or the disparate databases may convert such information to a format consumable by the ER database 1010 prior to relaying the converted data to the ER database 1010, and/or the ER database 1010 may consult a Savant interrogator 1008 operably connected thereto to help understand any incoming or retrieved EPC/RFID data. Regardless of whether EPC/RFID data is sent to the ER database 1010 for ingestion, such data may not be in a standardized format. The ER database 1010 may therefore convert disparate data inputs into a common format in certain exemplary embodiments. Once this data is stored in the ER database 1010 in a standardized or common format, using an active notification protocol and/or a subscription service, interested parties may be notified upon the occurrence of a suspect activity (e.g., one of the illustrative scenarios described above). The implementation of the active notification protocol and/or a subscription service advantageously is made possible because the ER database 1010 “homogenizes” the otherwise disparate inputs, thereby creating a large high-quality dataset in a format that is understandable, searchable, and capable of being manipulated so as to provide appropriate messages to interested parties in line with the exemplary techniques described herein.

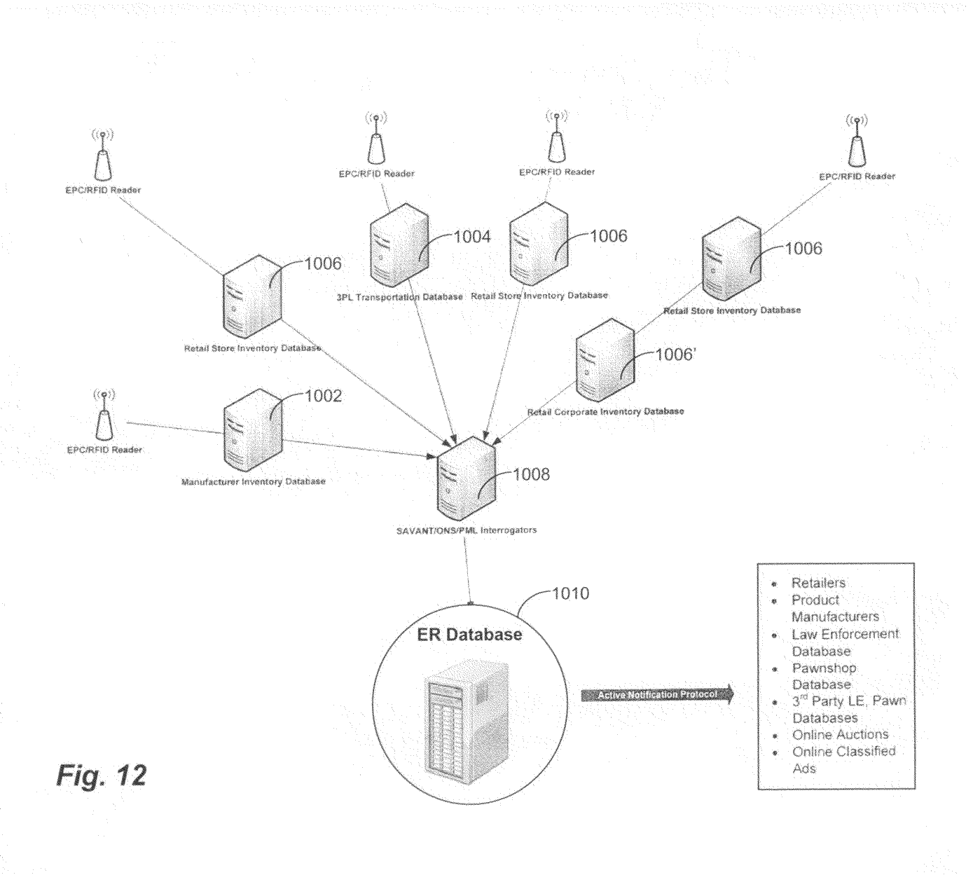

FIG. 12 is another illustrative schematic view of how system components may be oriented with respect to a centralized ER database in accordance with an exemplary embodiment. The FIG. 12 exemplary embodiment is similar to the FIG. 11 exemplary embodiment. One difference, however, is that the Savant interrogator 1008 is interposed between the individual databases and/or locations and the centralized ER database 1010. This arrangement effectively funnels all data through one or more interrogators 1008 and may in certain example instances reduce the amount of pre-processing required by the ER database 1010 before it can store the data in its tables (assuming that the data cannot be stored in its more native EPC/RFID or other format, which may be possible in certain exemplary embodiments). Rather than using the funnel approach in the FIG. 12 exemplary embodiment, however, a more distributed approach also may be used, e.g., wherein particular interrogators are paired or otherwise mapped to disparate data sources. This may reduce the overall processing burden compared to an arrangement that includes a single funnel-like arrangement.

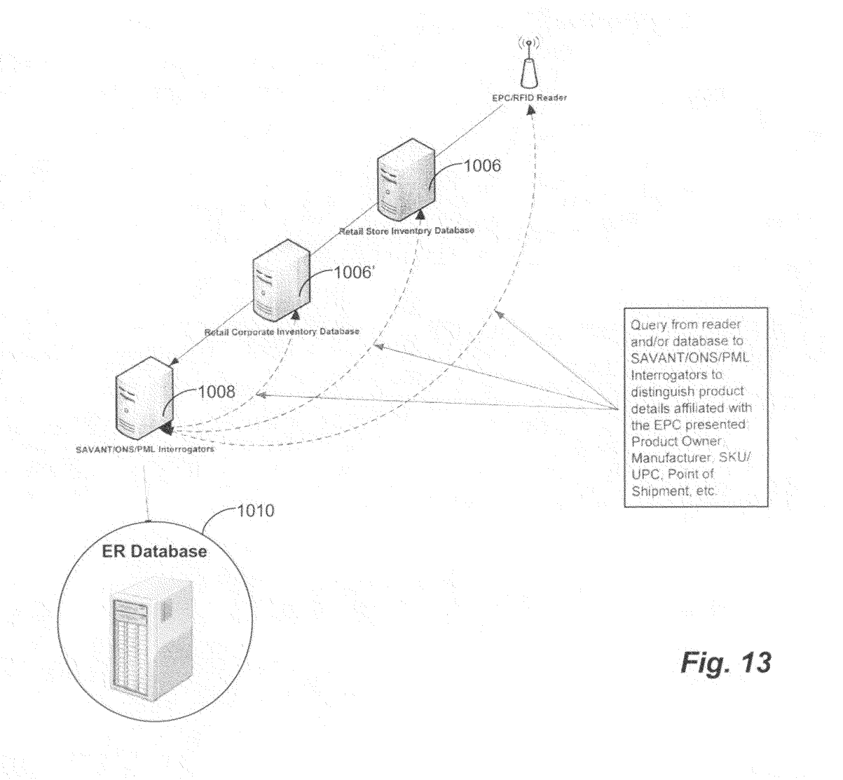

FIG. 13 is an illustrative schematic view showing how certain components may access and/or retrieve data from a centralized ER database in accordance with an exemplary embodiment. It will be appreciated that the FIG. 13 exemplary arrangement is merely a snippet of the FIG. 12 exemplary arrangement and, just as other arrangements are possible apart from the one shown in FIG. 12, so too are other arrangements possible apart from the FIG. 13 illustration. In any event, the procedure shown in FIG. 13 may be used when an item is presented for return. The item is scanned using the EPC/RFID reader (or unique information is inputted into the system by some other acceptable means). This information may be cross-referenced with the retail store inventory database 1006, the retail corporate inventory database 1006′ and/or the centralized ER database 1010. Because the data may originate in EPC/RFID format, it may be advantageous to query the Savant interrogator(s) 1008, e.g., in attempting to obtain data from the databases. The Savant interrogator(s) 1008 may, for example, help distinguish product details associated with the EPC presented. Such product details may include, for example, product owner, manufacturer, SKU/UPC, point of shipment, and/or the like. In other words, the Savant interrogator(s) 1008 may help “unpack” data stored in the EPC/RFID tag on the product presented, e.g., so that it can be compared with a target database, whether that database be a retailer database 1006 or 1006′, or the centralized ER database 1010.

With respect to data “unpacking,” an ONS and/or PML may be consulted. More particularly, when an interrogator reads an RFID tag, the EPC may be passed to the Savant which may, in turn, consult an Object Name Service or ONS (which is an automated networking service) on a local network or the Internet to find where information on the product is stored. The ONS may point the Savant 1008 to one of the databases shown in FIG. 13, for example, where a file about that product is stored. That file can then be retrieved by the Savant, and the file and/or underlying information about the product in the file may be forwarded back to the appropriate location, along with any codes regarding the status of the product (e.g., sale “ok,” item marked as lost/stolen, return period expired, etc.). The data may be stored according to, for example, the Physical Markup Language (PML), which is based on XML. The PML may help describe the items and, in general, may be hierarchical. PML files may be dynamically altered by authorized personnel, e.g., to reflect the status of the item or items that they describe.

The FIG. 13 exemplary embodiment may also or in the alternative implement the RFID product tracking techniques described in, for example, U.S. application Ser. No. 10/983,337, the entire contents of which are hereby incorporated herein by reference. Auction house and pawnshop product return systems also may be used in connection with certain exemplary embodiments described herein. Exemplary techniques are described in, for example, U.S. application Ser. No. 11/892,415, the entire contents of which are hereby incorporated herein by reference.

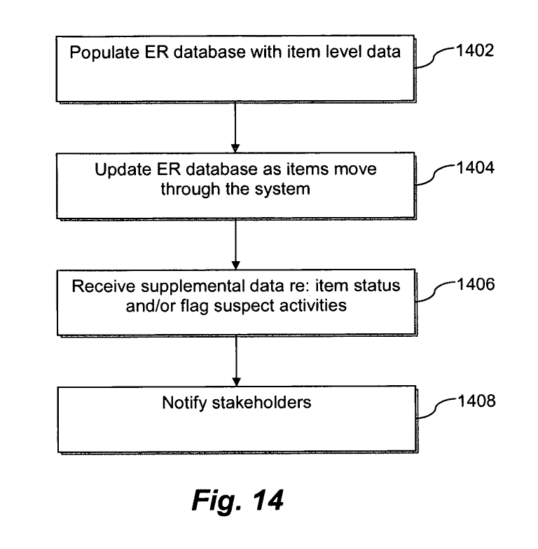

FIG. 14 is an exemplary flowchart for a maintaining a centralized ER database and sending out notifications. The ER database is populated with item-level data in step 1402.

This item-level data may be provided for a variety of sources including, for example, manufacturers, retailers, logistics providers, auction houses, pawnshops, etc. The item-level data may be provided in a variety of formats. For example, some data may be provided from an EPC/RFID scanner. Other data may be provided from a barcode scanner. Still other data may be manually entered. The ER database may therefore need to convert the data to a common, consumable format (e.g., in one or more steps not shown) prior to storing it. Checks also may be made to help ensure that the necessary or desirable item-level data is available to the ER database.

There are various types of information that may be collected at the “touchpoint” and/or transmitted to the centralized ER database. A first example may include only EPC/RFID collection, and EPC/RFID transmission. A second example may include gathering EPC/RFID information that is related to a serial number, and transmitting the serial number. A third example may include gathering EPC/RFID information that is related to a serial number, and transmitting the EPC/RFID. A fourth example may include gathering EPC/RFID information that is related to a serial number, and transmitting the serial number and the EPC/RFID. A fifth example may include gathering EPC/RFID information that is related to a serial number, and transmitting a unique numeric, alpha, or alphanumeric code. Such a code may be generated using an algorithm based on, for example, the EPC and/or serial number. The algorithm may be as simple as a hashing algorithm and may therefore help protect the identity of the product and/or person purchasing the product. Of course, other possibilities for data gathering and/or transmission also are possible.

In any event, in step 1404, the ER database is updated as the item moves throughout the global sales universe. Updates may include sending items from a manufacture to a retailer through a common carrier, selling the item, return or warranty service for the item, reports of loss for the item, etc. Although some of this information may be automatically logged, e.g., from suitably configured sales or return/warranty systems, supplemental data may be provided from an authorized entity and/or suspected activities may be anticipatorily flagged in step 1406. Stakeholders who have been preselected or subscribed to feeds regarding the items may be notified of the changed status or anticipated problem in step 1408. The stakeholders may take appropriate action at that time (e.g., instituting an investigation, closing an investigation, prosecuting an individual, etc.). Detection programmed logic circuitry, notification programmed logic circuitry, subscription programmed logic circuitry, and/or the like may be used and/or be suitably configured to help accomplish these and/or other tasks and functions, as appropriate.

The ability to share information among so many disparate parties that often are concerned with different data to be used for different purposes is advantageous for a number of reasons. In addition to helping maintain the integrity of the overall supply chain, locate and return missing/stolen products, and/or keeping B-goods or gray-market goods out of standard circulation, the ability to share information among so many disparate parties also may be advantageous for building a common case against a party. Although it is sometimes possible to recover stolen or lost property, it is not always easy to determine what went wrong and/or who is to blame. The ability to track an item through all or substantially all points in the sales world may help to identify more and more persons in the chain of wrongdoing, including the originally culpable party as well as the party that “got caught.” Furthermore, even when there is only one party involved, it is sometimes difficult to build a case against the person because of poor recordkeeping, lack of chain of custody information, inability to track the accused person's activities, and/or the like. However, certain exemplary embodiments described herein may help build a common case against the person by monitoring activities associated with the item, even as it changes hands or is about to change hands.

Certain exemplary embodiments may be thought of as being global. This may mean that the ER database may function across disparate systems throughout all or substantially all of an item's or a product's lifecycle (e.g., from manufacture to shipment to sale to return, etc.). The various system components may be located around the world and the system may be said to be global in this sense, as well. It will be appreciated that the ER database storing product related sales, return, warranty, and/or other information, and the CPD database including the flags for various products, etc., may be implemented together in one large and multi-functional database (generally referred to herein as an ER database) comprising one or more tables and/or other data structures in certain exemplary embodiments. However, in certain exemplary embodiments, different databases and/or tables may be provided. In certain exemplary implementations, the one or more databases and/or tables may be linked together to function as a cohesive electronic registration (ER) system to provide for global product recovery and/or fraud detection.

While the invention has been described in connection with exemplary illustrative non-limiting implementations, it is to be understood that the invention is not to be limited to the disclosed implementations, but on the contrary, is intended to cover various modifications and equivalent arrangements included within the spirit and scope of the appended claims.

What is claimed is:

1. A computer-implemented method for identifying the movement of suspect items, the method comprising:
receiving item-level data for a plurality of items at a centralized electronic registration (ER) database connected to a network;
updating the item-level data in the centralized ER database as items in said plurality of items progress through respective product lifecycles; and
notifying stakeholders upon each occurrence of an unexpected event being detected by the ER database and upon each time a particular item in the plurality of items is flagged as being lost or stolen.

2. The method of claim 1, the item-level data is received from manufacturers, retailers, and logistics providers.

3. The method of claim 1, wherein the item-level data is received from EPC/RFID readers.

4. The method of claim 2, wherein the updating is performed each time an item is transferred from a manufacturer to a logistics provider, a logistics provider to a retailer, and a retailer to a consumer.

5. The method of claim 2, wherein the updating also is performed each time a consumer initiates a warranty or return request for an item.

6. The method of claim 5, wherein the unexpected event is any one or more of the following events: a sold item being presented for sale after an original sale date associated with the item, an item marked as lost or stolen being presented for sale, and an item marked as lost or stolen being presented for return.

7. The method of claim 6, further comprising receiving subscription requests from stakeholders, each said subscription request identifying an item or group of items to be monitored for a specified unexpected event.

8. The method of 7, further comprising performing said notifying in dependence on the received subscription requests.

9. The method of claim 6, further comprising performing said notifying based on subscription requests from stakeholders and predefined rules.

10. The method of claim 9, wherein the predefined rules specify that an entity that provided the item-level data for the item is to be notified and/or that a last entity and a next entity in the chain-of-custody is to be notified, when the unexpected event is detected and when the particular item is flagged.

11. An electronic registration system, comprising:
a centralized electronic registration (ER) database connected to a network, the ER database being configured to receive item-level data for a plurality of items from a plurality of touchpoints in a global sales system and being configured to update the item-level data as items in said plurality of items progress through respective product lifecycles;
detection programmed logic circuitry configured to detect any (a) occurrences of unexpected events pertaining to the items in the ER database, and (b) flagging of items in the ER database as being lost or stolen; and
notification programmed logic circuitry configured to notify stakeholders in dependence on output from the detection programmed logic circuitry.

12. The system of claim 11, the item-level data is received from computer systems belonging to manufacturers, retailers, and logistics providers.

13. The system of claim 11, wherein the item-level data is received from EPC/RFID readers connected to computer systems belonging to manufacturers, retailers, and logistics providers.

14. The system of claim 12, wherein the ER database is updatable each time an item is transferred from a manufacturer to a logistics provider, a logistics provider to a retailer, and a retailer to a consumer.

15. The system of claim 12, wherein the ER database is updatable each time a consumer initiates a warranty or return request for an item.

16. The system of claim 15, wherein the unexpected event is any one or more of the following events: a sold item being presented for sale after an original sale date associated with the item, an item marked as lost or stolen being presented for sale, and an item marked as lost or stolen being presented for return.

17. The system of claim 16, further comprising subscription programmed logic circuitry configured to receive subscription requests from stakeholders, each said subscription request identifying an item or group of items to be monitored for a specified unexpected event.

18. The system of 17, wherein said notification programmed logic circuitry is configured to notify at least some of the stakeholders in dependence on the received subscription requests.

19. The system of claim 16, wherein said notification programmed logic circuitry is configured to send notifications based on subscription requests from stakeholders and predefined rules.

20. The system of claim 19, wherein the predefined rules specify that an entity that provided the item-level data for the item is to be notified and/or that a last entity and a next entity in the chain-of-custody is to be notified, when the unexpected event is detected and when the particular item is flagged.
